(19) United States
(12) Patent Application Publication
(10) Pub. No.: US 2010/0254119 A1
(43) Pub. Date: Oct. 7, 2010

(54) LIGHT SOURCE CONNECTION MEMBER, LIGHT EMITTING DEVICE AND DISPLAY DEVICE

(75) Inventor: Shuichi Naijo, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/743,736

(22) PCT Filed: Nov. 18, 2008
(86) PCT No.: PCT/JP2008/070895

§ 371 Date: May 19, 2010

(30) Foreign Application Priority Data
Nov. 20, 2007 (JP) 2007-300954

(51) Int. Cl. G02F 1/13357; F21S 4/00; F21V 9/00; F21V 1/00

(52) U.S. Cl. 362/97.1; 362/227; 362/231; 362/249.01; 362/235

(57) ABSTRACT

A light source connection member (33) is provided with a front surface light emitting unit (32a) on which a front surface red color LED (61a), a front surface first green color LED (62a), a front surface second green color LED (63a) and a front surface blue color LED (64a) that emit light from the front surface of the light source connection member (33) are mounted; a rear surface light emitting unit (32b) on which a rear surface red color LED (61b), a rear surface first green color LED (62b), a rear surface second green color LED (63b) and a rear surface blue color LED (64b) that emit light from a rear surface side are mounted; and a connection member (34) that connects the front surface light emitting unit (32a) with the rear surface light emitting unit (32b). Further, a connection member (34) has an electric conductor (40) electrically connected to each color LED provided at the front surface light emitting unit (32a) and the rear surface light emitting unit (32b), respectively.

### TECHNICAL FIELD

The present invention relates to a light source connection member formed by connecting plural light sources to each other, and the like.

### BACKGROUND ART

In recent years, various light emitting devices using light-emitting elements such as light-emitting diodes (LEDs) have come into practical use. Such light emitting devices are widely used, for example, as an illumination device as a substitute for fluorescent tubes, a backlight for a liquid crystal panel of a liquid crystal display device, and the like.

As this type of the light emitting device, a light source connection member that includes plural light sources having electric connection and a connection conductor structure extending in an array direction of the light sources for connecting the plural light sources has been proposed. Here, in the connection conductor structure, a certain part of a substantially flat pattern conductor on which a predetermined pattern is formed is eliminated (See Patent Document 1).

Further, another light source connection member has been proposed in which, to each of 3 or more groups of lead frames, plural light emitting diode chips having the same color are serially connected, and 3 or more different color light emitting diode chips provided in the respective lead frames are integrally sealed with transparent resin or transparent sealant (See Patent Documents 2 and 3).

Patent Document 1: WO2002/089222

Patent Document 2: Japanese Patent Application Laid Open Publication No. 2006-134992

Patent Document 3: Japanese Patent Application Laid Open Publication No. 2006-134996

### DISCLOSURE OF THE INVENTION

### Problems to be Solved by the Invention

In the above-mentioned light source connection member, the LEDs (light emitting diode chips) are attached so as to emit light in the same direction. Thus, in a case where a double-sided light source emitting light in directions opposite to each other is configured by using such a light source connection member, two light source connection members are necessary to be prepared, and to attach the light source connection members to each other so that the light emitting directions of the light connection members are opposite to each other, and thereby the number of the components forming the double-sided light source is increased.

The present invention has been made on the basis of the above-mentioned technique, and the main object thereof is to provide a light source connection member emitting light in the directions opposite to each other with a simple configuration, and the like.

### Means for Solving the Problems

In order to attain the above object, there is provided a light source connection member to which the present invention is applied, including: a plurality of light sources; and a metallic conductor that has a front surface and a rear surface and through which the plurality of light sources are connected to each other to form the light source connection member. The metallic conductor includes an electric conductor that is electrically connected to the plurality of light sources and that forms an electric power supply route for the plurality of light sources, and the plurality of light sources include a front surface light source that emits light from the front surface side of the metallic conductor and a rear surface light source that emits light from the rear surface side of the metallic conductor.

In such a light source connection member, the metallic conductor further includes a heat conductor that is provided so as to be electrically isolated from the electric conductor on the same plane as the electric conductor, and that forms a heat radiation route for heat produced by the front surface light source and the rear surface light source. In this case, the front surface light source includes a front surface light emitting element that is attached to the front surface of the heat conductor, and the rear surface light source includes a rear surface light emitting element that is attached to the rear surface of the heat conductor.

Further, in such a light source connection member, each of the front surface light source and the rear surface light source includes a red light emitting unit, a green light emitting unit and a blue light emitting unit, respectively, and the electric conductor includes a red electric conductor that serially connects the red light emitting unit provided to the front surface light source and the red light emitting unit provided to the rear surface light source to each other, a green electric conductor that serially connects the green light emitting unit provided to the front surface light source and the green light emitting unit provided to the rear surface light source to each other, and a blue electric conductor that serially connects the blue light emitting unit provided to the front surface light source and the blue light emitting unit provided to the rear surface light source to each other.

In another aspect of the present invention, there is provided a light emitting device including: a frame that has a back surface portion and side surface portions enclosing the back surface portion; and a band-shaped light source that is formed by connecting a plurality of light sources through a metallic conductor having a front surface and a rear surface, and that is attached to the frame. The metallic conductor includes an electric conductor that is electrically connected to the plurality of light sources and that forms an electric power supply route for the plurality of light sources, the plurality of light sources includes a front surface light source that emits light from the front surface side of the metallic conductor and a rear surface light source that emits light from the rear surface side of the metallic conductor, and the band-shaped light source is attached to the frame so that the front surface light source and the rear surface light source face the side surface portions, respectively.

In such a light emitting device, the back surface portion of the frame includes a reflection body formed on the back surface portion, the reflection body being provided along the band-shaped light source, and reflecting light emitted by the front surface light source and the rear surface light source.

In further aspect of the present invention, there is provided a display device including: a display panel that displays an image; and a backlight that is provided on a back side of the display panel, and that illuminates the display panel with light. The backlight includes: a frame that has a back surface portion arranged so as to face the display panel, and side surface portions enclosing the back surface portion; and a plurality of band-shaped light sources that are each formed by connecting a plurality of light sources through a metallic conductor having a front surface and a rear surface, and that are attached to the frame so as to be arrayed. The metallic conductor includes an electric conductor that is electrically connected to the plurality of light sources and that forms an electric power supply route for the plurality of light sources, the plurality of light sources includes a front surface light source that emits light from the front surface side of the metallic conductor and a rear surface light source that emits light from the rear surface side of the metallic conductor, and each of the plurality of band-shaped light sources is attached to the frame so that the front surface light source and the rear surface light source face the side surface portions, respectively.

In such a display device, in each of the plurality of band-shaped light sources, arrangement of the front surface light source and the rear surface light source at each column is the same.

### ADVANTAGES OF THE INVENTION

According to the present invention, it is possible to provide a light source connection member emitting light in directions opposite to each other with a simple configuration, and the like.

### BEST MODES FOR CARRYING OUT THE INVENTION

Hereinafter, best modes for achieving the present invention (hereinafter, referred to as an exemplary embodiment) will be described in detail with reference to the accompanying drawings.

### Exemplary Embodiment

FIG. 1 is a view showing an entire configuration of a liquid crystal display device to which the exemplary embodiment is applied. Note that, in FIG. 1, a vertical direction V and a horizontal direction H of the liquid crystal display device are shown with arrows. In addition, in FIG. 1, a front side F and a rear side R of the vertical direction V of the liquid crystal display device are also shown with an arrow.

The liquid crystal display device to which the present exemplary embodiment is applied has a length in the horizontal direction H longer than that in the vertical direction V. Further, the liquid crystal display device includes a liquid crystal display module 20, and a backlight device (backlight) 10 provided on a back side of the liquid crystal display module 20 (a lower side in FIG. 1).

The backlight device 10, serving as a light emitting device, includes a backlight frame (frame) 11 that equips with light sources, and a light emitting module 12 in which multiple light emitting diodes (referred to as LEDs in the following description) are arrayed. Moreover, the backlight device 10 includes a diffusing sheet 13 that is a transparent sheet (or film), as a laminate of optical films, for scattering and diffusing light for obtaining uniform lightness on the entire plane, and prism sheets 14 and 15 formed of diffraction grating films having a light focusing function toward the front side. In addition, the backlight device 10 includes, as necessary, a brightness improvement film 16 with diffusion and reflection type for improving the brightness.

On the other hand, the liquid crystal display module 20 includes a liquid crystal panel 21 composed of two glass substrates with liquid crystal in between, and polarization plates 22 and 23 stacked on the respective glass substrate of the liquid crystal panel 21 for restricting the oscillation of optical wave to a given direction. Further, to the liquid crystal display device, peripheral members such as an LSI for driving (not shown in the figure) are equipped.

The liquid crystal panel 21 includes various structural components not shown in the figure. For example, the two glass substrates have display electrodes, active elements such as a thin film transistor (TFT: thin film transistor), liquid crystal, a spacer, sealant, an orientation film, a common electrode, a protective film, a color filter, and the like which are not shown in the figure.

Incidentally, the structural unit of the backlight device 10 may be selected in an arbitrary way. For example, the unit including only the backlight frame 11 having the light emitting module 12 may be called as a “backlight device (backlight)” and distributed as a service unit not including the diffusing sheet 13, the prism sheets 14 and 15, and the brightness improvement film 16.

FIGS. 2A, 2B and 2C are views for explaining the configurations of the backlight frame 11 and the light emitting module 12 in the backlight device 10, and FIG. 2A is a top view of the backlight device 10 viewed from the upper side of FIG. 1. FIG. 2B is a cross-sectional view of FIG. 2A taken along a line IIB-IIB. FIG. 2C is a cross-sectional view of FIG. 2A taken along a line IIC-IIC.

The backlight frame 11 has a chassis structure made of, for example, aluminum, magnesium, iron, or a metallic alloy including these materials. To the inside of the chassis structure, a polyester film or the like having a high performance of reflecting white light is adhered, for example. The polyester film also functions as a reflector. The chassis structure is composed of a back surface portion corresponding to the size of the liquid crystal display module 20 and side surface portions enclosing the four sides of the back surface portion. On the back surface portion or the side surface portions, a heat sink configuration including a cooling fin for exhaust heat may be provided as necessary. To the both end portions of the back surface portion of the backlight frame 11 on the short sides, connectors 11a and 11b for supplying electric power to LEDs forming the light emitting module 12 are respectively provided.

As shown in FIGS. 2B and 2C, on the back surface portion of the backlight frame 11, reflection bodies 100 that reflect light emitted by the light emitting module 12 toward the liquid crystal panel 21 are provided. Each of the reflection bodies 100 forms a row having a shape like a mound projecting toward the liquid crystal panel 21. The reflection bodies 100 are provided so that each of the ridge lines thereof (dashed-dotted lines shown in FIG. 2A) extends along the horizontal direction H. Seven rows of the reflection bodies 100 are provided at the same intervals on the back surface portion of the backlight frame 11, and thereby, 6 rows of concave portions and 7 rows of convex portions are formed on the back surface portion of the backlight frame 11.

The light emitting module 12 includes plural band-shaped light sources 31 (in the present exemplary embodiment, 6 rows of the band-shaped light sources 31) that are each arranged along the horizontal direction H of the backlight frame 11. Each of the rows of the plural band-shaped light sources 31 is provided between the adjacent two reflection bodies 100 on the back surface portion of the backlight frame 11. In other words, each of the rows of the band-shaped light sources 31 is arranged on each of the rows of the convex portions formed on the backlight frame 11. Further, one end side of each of the band-shaped light sources 31 is electrically connected to the connector 11a, and the other side thereof is electrically connected to the connector 11b.

Plural light emitting units 32 (in this example, 16 light emitting units 32) are provided to each of the band-shaped light sources 31 at approximately the same intervals. The plural light emitting units 32 are provided thereto so that light emission surfaces of the light emitting units 32 face the side surface portions along the horizontal direction H of the backlight frame 11 in a state where the band-shaped light sources 31 are attached to the backlight frame 11. In other words, the band-shaped light sources 31 are attached thereto in a state of standing on the backlight frame 11. By this configuration, the plural light emitting units 32 emit light in a direction along the back surface portion of the backlight frame 11 (direction along the liquid crystal panel 21).

The light emitting units 32, serving as light sources, include front surface light emitting units 32a (front surface light sources) that emit light toward the front side F in the vertical direction V, and rear surface light emitting units 32b (rear surface light sources) that emit light toward the rear side R therein. In each of the band-shaped light sources 31, the front surface light emitting units 32a and the rear surface light emitting units 32b are alternately provided. Note that, each of the band-shaped light sources 31 is attached to the backlight frame 11 so that one of the front surface light emitting units 32a is located on the left end of each of the band-shaped light sources 31 in the horizontal direction H. Thus, in each of the band-shaped light sources 31, odd-numbered light emitting units 32 from the left end are the front surface light emitting units 32a, while even-numbered light emitting units 32 therefrom are the rear surface light emitting units 32b.

By this configuration, light emitting directions of the light emitting units 32 are the same when the light emitting units 32 of the light emitting module 12 are viewed in the vertical direction V. For example, as shown in FIG. 2B, in the cross section where each 7^{th} (odd-numbered) light emitting unit 32 from the left end is located, 6 front surface light emitting units 32a emitting light toward the front side F are arrayed in the vertical direction V. On the other hand, as shown in FIG. 2C, in the cross section where each 8^{th} (even-numbered) light emitting unit 32 from the left end is located, 6 rear surface light emitting units 32b emitting light toward the rear side R are arrayed in the vertical direction V. In other words, if the 6 light emitting units 32 arranged in the vertical direction V is assumed to be one group, 16 columns of the groups are attached to the backlight frame 11. Here, the 16 columns of the groups are formed of groups in which the light emitting direction corresponds to the front side F and groups in which the light emitting direction corresponds to the rear side R, and these two groups are alternately arranged in the horizontal direction H.

FIGS. 3A and 3B show a light source connection member 33 as a basic unit forming the band-shaped light source 31. Here, FIG. 3A shows the front surface side of the light source connection member 33 corresponding to the front side F of the band-shaped light source 31 attached to the backlight frame 11, and FIG. 3B shows the rear surface side of the light source connection member 33 corresponding to the rear side R of the band-shaped light source 31 attached to the backlight frame 11. Note that, the above-mentioned band-shaped light source 31 is formed of the plural light source connection members 33 connected to each other.

In the present exemplary embodiment, each of the light source connection members 33 includes 4 light emitting units 32, that is, a first light emitting unit 321, a second light emitting unit 322, a third light emitting unit 323 and a fourth light emitting unit 324 from the left side of FIGS. 3A and 3B. Here, the front surface light emitting units 32a are formed of the first light emitting unit 321 and the third light emitting unit 323, while the rear surface light emitting units 32b are formed of the second light emitting unit 322 and the fourth light emitting unit 324. In other words, also in the light source connection member 33, the front surface light emitting units 32a and the rear surface light emitting units 32b are alternately provided so as to correspond to the above-mentioned band-shaped light source 31.

The light emitting units 32 (front surface light emitting units 32a and rear surface light emitting units 32b) have a function that emits the three primary colors of light, that is, red (R) light, green (G) light and blue (B) light. Moreover, in the present exemplary embodiment, each of the light emitting units 32 includes four LEDs, that is, the light emitting elements.

For example, as shown in FIG. 3A, the first light emitting unit 321 (front surface light emitting unit 32a) includes a front surface red color LED 61a that emits red light from the front surface thereof, a front surface first green color LED 62a that emits green light from the front surface thereof, a front surface second green color LED 63a that also emits green light from the front surface thereof and a front surface blue color LED 64a that emits blue light from the front surface thereof. The same configuration is applied to the third light emitting unit 323.

Note that, the front surface LEDs (front surface light emitting elements) are formed of the front surface red color LED 61a, the front surface first green color LED 62a, the front surface second green color LED 63a and the front surface blue color LED 64a. Note that, in the present exemplary embodiment, the front surface red color LED 61a functions as a red light emitting unit, the front surface first green color LED 62a and the front surface second green color LED 63a function as green light emitting units, and the front surface blue color LED 64a functions as a blue light emitting unit.

On the other hand, as shown in FIG. 3B, the second light emitting unit 322 (rear surface light emitting unit 32b) includes a rear surface red color LED 61b that emits red light from the rear surface thereof, a rear surface first green color LED 62b that emits green light from the rear surface thereof, a rear surface second green color LED 63b that also emits green light from the rear surface thereof and a rear surface blue color LED 64b that emits blue light from the rear surface thereof. The same configuration is applied to the fourth light emitting unit 324.

Note that, the rear surface LEDs (rear surface light emitting elements) are formed of the rear surface red color LED 61b, the rear surface first green color LED 62b, the rear surface second green color LED 63b and the rear surface blue color LED 64b. Note that, in the present exemplary embodiment, the rear surface red color LED 61b functions as the red light emitting unit, the rear surface first green color LED 62b and the rear surface second green color LED 63b function as the green light emitting units, and the rear surface blue color LED 64b functions as the blue light emitting unit.

The first light emitting unit 321, the second light emitting unit 322, the third light emitting unit 323 and the fourth light emitting unit 324 each have a reflection member 60 having a light reflecting function.

Each of the light source connection members 33 includes a connection member 34 that connects the light emitting units 32 in a linear fashion. The connection member 34 as a metallic conductor has an electric conductor 40 that electrically connects the light emitting units 32, and a heat conductor 50 that thermally connects the light emitting units 32. As a base material of the connection member 34, copper, iron, aluminum, a metallic alloy including these materials or the like is usable. Note that, the connection member 34, that is, the electric conductor 40 and the heat conductor 50, are made by punching processing for the metallic plate (for example, copper plate) having the thickness of 0.15 mm and having a band shape, for example. Thereby, the electric conductor 40 and the heat conductor 50 forming the connection member 34 are formed on the same plane.

Respective parts of the electric conductor 40 and the heat conductor 50 forming the connection member 34 are also formed inside the reflection members 60. On exposed portions of the electric conductor 40, which are not covered by the reflection members 60 and which are exposed to the outside, an insulation layer (not shown in the figure) formed of, for example, a white resist or the like, is formed. Meanwhile, such an insulation layer is not formed for the heat conductor 50, and a copper layer or a plated layer made of silver, nickel or the like, formed on the copper layer (not shown in the figure) is exposed to the outside.

The electric conductor 40 includes a red electric conductor 41, a first green electric conductor 42, a second green electric conductor 43 and a blue electric conductor 44. Among them, the red electric conductor 41 serially connects the front surface red color LEDs 61a provided to the first light emitting unit 321 and the third light emitting unit 323 and the rear surface red color LEDs 61b provided to the second light emitting unit 322 and the fourth light emitting unit 324 to each other. Further, the first green electric conductor 42 serially connects the front surface first green color LEDs 62a provided to the first light emitting unit 321 and the third light emitting unit 323 and the rear surface first green color LEDs 62b provided to the second light emitting unit 322 and the fourth light emitting unit 324 to each other. Furthermore, the second green electric conductor 43 serially connects the front surface second green color LEDs 63a provided to the first light emitting unit 321 and the third light emitting unit 323 and the rear surface second green color LEDs 63b provided to the second light emitting unit 322 and the fourth light emitting unit 324 to each other. Still furthermore, the blue electric conductor 44 serially connects the front surface blue color LEDs 64a provided to the first light emitting unit 321 and the third light emitting unit 323 and the rear surface blue color LEDs 64b provided to the second light emitting unit 322 and the fourth light emitting unit 324 to each other.

On the other hand, the heat conductor 50 includes a first heat conductor 51 and a second heat conductor 52. Among them, to the first heat conductor 51, the front surface red color LEDs 61a and the front surface first green color LEDs 62a provided to the first light emitting unit 321 and the third light emitting unit 323 and the rear surface red color LEDs 61b and the rear surface first green color LEDs 62b provided to the second light emitting unit 322 and the fourth light emitting unit 324 are directly attached. On the other hand, to the second heat conductor 52, the front surface second green color LEDs 63a and the front surface blue color LEDs 64a provided to the first light emitting unit 321 and the third light emitting unit 323 and the rear surface green color LEDs 63b and the rear surface blue color LEDs 64b provided to the second light emitting unit 322 and the fourth light emitting unit 324 are directly attached.

Moreover, plural opening holes 53 are formed along a longitudinal direction in each of the first heat conductor 51 and the second heat conductor 52.

In the present exemplary embodiment, the first heat conductor 51 and the second heat conductor 52 which form the heat conductor 50 are arranged so as to sandwiching the red electric conductor 41, the first green electric conductor 42, the second green electric conductor 43 and the blue electric conductor 44 which form the electric conductor 40. In other words, the electric conductor 40 is formed between the first heat conductor 51 and the second heat conductor 52.

Here, lengths, in a direction orthogonal to the longitudinal direction, of the red electric conductor 41, the first green electric conductor 42, the second green electric conductor 43 and the blue electric conductor 44, that is, widths thereof, are set to be the same. Also, the widths of the first heat conductor 51 and the second heat conductor 52 are set to be the same. However, the width of each of the first heat conductor 51 and the second heat conductor 52 is set wider than the width of each of the red electric conductor 41, the first green electric conductor 42, the second green electric conductor 43 and the blue electric conductor 44. Thereby, the first heat conductor 51 and the second heat conductor 52 have higher mechanical strength than the red electric conductor 41, the first green electric conductor 42, the second green electric conductor 43 and the blue electric conductor 44.

On the both end sides of the light source connection member 33 in the longitudinal direction, terminal portions 35 are provided. Here, the terminal portions 35 are used for connections with other light source connection members 33, the connectors 11a and 11b shown in FIG. 2A or the like.

Note that, in the connection member 34, the electric conductor 40 and the heat conductor 50 are electrically isolated, that is, insulated. Also, the red electric conductor 41, the first green electric conductor 42, the second green electric conductor 43 and the blue electric conductor 44 forming the electric conductor 40 are electrically isolated, that is, insulated from each other.

Next, with reference to FIGS. 4 and 5, a detailed description of the light source connection member 33 will be given.

FIG. 4 is a view for explaining a wiring structure of the light source connection member 33, attachment of each LED, and the configuration of the terminal portion 35. Here, the description will be given by taking the first light emitting unit 321 and the second light emitting unit 322 shown in FIG. 3 as an example. Note that, the attachment condition of each LED to the third light emitting unit 323 is the same as that to the first light emitting unit 321, and the attachment condition of each LED to the fourth light emitting unit 324 is the same as that to the second light emitting unit 322. In FIG. 4, the first light emitting unit 321 emitting light toward the front side in the figure is shown with solid lines, while the second light emitting unit 322 emitting light toward the rear side in the figure is shown with broken lines. FIG. 5 is a cross-sectional view of FIG. 4 taken along a line V-V.

In the first light emitting unit 321 (front surface light emitting unit 32a) shown on the left side of FIG. 4, the first heat conductor 51 includes a first projection portion 54 which has a crank shape and which is formed so as to project downward in the figure. The red electric conductors 41 are arranged so as to sandwich the first projection portion 54. The front surface red color LED 61a is attached on the front surface side of the first projection portion 54 sandwiched by the two red electric conductors 41. Also, the first green electric conductors 42 are arranged so as to sandwich the first projection portion 54. The front surface first green color LED 62a is attached on the front surface side of the first projection portion 54 sandwiched by the two first green electric conductors 42.

Here, the two red electric conductors 41 and the front surface red color LED 61a are electrically connected to each other through bonding wires not shown in the figure. Also, the two first green electric conductors 42 and the front surface first green color LED 62a are electrically connected to each other through bonding wires not shown in the figure. Each of the first projection portion 54, the front surface red color LED 61a and the front surface first green color LED 62a is electrically insulated. In the present exemplary embodiment, the front surface red color LED 61a is attached onto the first projection portion 54 so as to be located on a side closer to the first heat conductor 51 than the front surface first green color LED 62a is.

The second heat conductor 52 includes a second projection portion 55 which has a crank shape and which is formed so as to project upward in the figure. The second green electric conductors 43 are arranged so as to sandwich the second projection portion 55. The front surface second green color LED 63a is attached on the front surface side of the second projection portion 55 sandwiched by the two second green electric conductors 43. Also, the blue electric conductors 44 are arranged so as to sandwich the second projection portion 55. The front surface blue color LED 64a is attached on the front surface side of the second projection portion 55 sandwiched by the two blue electric conductors 44.

Here, the two second green electric conductors 43 and the front surface second green color LED 63a are electrically connected to each other through bonding wires not shown in the figure. Also, the two blue electric conductors 44 and the front surface blue color LED 64a are electrically connected to each other through bonding wires not shown in the figure. Each of the second projection portion 55, the front surface second green color LED 63a and the front surface blue color LED 64a is electrically insulated. In the present exemplary embodiment, the front surface blue color LED 64a is attached onto the second projection portion 55 so as to be located on a side closer to the second heat conductor 52 than the front surface second green color LED 63a is.

Also in the second light emitting unit 322 (rear surface light emitting unit 32b) shown on the right side of FIG. 4, similarly to the first light emitting unit 321, the first heat conductor 51 includes the first projection portion 54 which has the crank shape and which is formed so as to project downward in the figure. The red electric conductors 41 are arranged so as to sandwich the first projection portion 54. The rear surface red color LED 61b is attached on the rear surface side of the first projection portion 54 sandwiched by the two red electric conductors 41. Also, the first green electric conductors 42 are arranged so as to sandwich the first projection portion 54. The rear surface first green color LED 62b is attached on the rear surface side of the first projection portion 54 sandwiched by the two first green electric conductors 42.

Here, also in the second light emitting unit 322, similarly to the first light emitting unit 321, the two red electric conductors 41 and the rear surface red color LED 61b are electrically connected to each other through bonding wires not shown in the figure. Also, the two first green electric conductors 42 and the rear surface first green color LED 62b are electrically connected to each other through bonding wires not shown in the figure. Each of the first projection portion 54, the rear surface red color LED 61b and the rear surface first green color LED 62b is electrically insulated. In the present exemplary embodiment, the rear surface red color LED 61b is attached onto the first projection portion 54 so as to be located on a side closer to the first heat conductor 51 than the rear surface first green color LED 62b is.

Also in the second light emitting unit 322, the second heat conductor 52 includes the second projection portion 55 which has the crank shape and which is formed so as to project upward in the figure. The second green electric conductors 43 are arranged so as to sandwich the second projection portion 55. The rear surface second green color LED 63b is attached on the rear surface side of the second projection portion 55 sandwiched by the two second green electric conductors 43. Also, the blue electric conductors 44 are arranged so as to sandwich the second projection portion 55. The rear surface blue color LED 64b is attached on the rear surface side of the second projection portion 55 sandwiched by the two blue electric conductors 44. Here, the two second green electric conductors 43 and the rear surface second green color LED 63b are electrically connected to each other through bonding wires not shown in the figure.

Also, the two blue electric conductors 44 and the rear surface blue color LED 64b are electrically connected to each other through bonding wires not shown in the figure. Each of the second projection portion 55, the rear surface second green color LED 63b and the rear surface blue color LED 64b is electrically insulated. In the present exemplary embodiment, the rear surface blue color LED 64b is attached onto the second projection portion 55 so as to be located on a side closer to the second heat conductor 52 than the rear surface second green color LED 63b is.

As described above, the same color LEDs included in the front surface LEDs and the rear surface LEDs are serially connected to each other through the corresponding color electric conductor, although the light emitting directions thereof are different since the light emitting direction of the front surface LEDs corresponds to the front surface side and the light emitting direction of the rear surface LEDs corresponds to the rear surface side. Similarly, the heat conductor 50 is mutually used by the front surface LEDs and the rear surface LEDs. Accordingly, for example, the number of the necessary electric conductors can be reduced in comparison with a case where the electric conductors are separately provided for the front surface LEDs and the rear surface LEDs.

Note that, as shown in FIG. 4, in each of the first light emitting unit 321 (front surface light emitting unit 32a) and the second light emitting unit 322 (rear surface light emitting unit 32b), plural holes (in this example, 4 holes) are formed on each of a connecting section between the first heat conductor 51 and the first projection portion 54 and a connecting section between the second heat conductor 52 and the second projection portion 55. These holes are provided for increasing adhesiveness between the resin forming the reflection member 60 and the heat conductor 50, that is, the first heat conductor 51 and the second heat conductor 52.

Further, with reference to FIG. 5, a description of the reflection member 60 will be given. Here, the description will be given by taking the cross section of the first light emitting unit 321 as an example.

The reflection member 60 is formed into a square and planar shape (see FIG. 4), and made of a white resist material, for example. The reflection member 60 includes a base 60a projecting on a side opposite to a mounting surface for the color LEDs, and a reflection portion 60b projecting on the mounting surface side for the color LEDs. Here, the reflection member 60 is formed so as to stride the first heat conductor 51, the electric conductor 40 (the red electric conductor 41, the first green electric conductor 42, the second green electric conductor 43 and the blue electric conductor 44) and the second heat conductor 52. In the reflection portion 60b, four reflection walls 60c, in total, are formed. Here, each of the reflection walls 60c has a center corresponding to the attachment position of the corresponding color LED. In order to seal the reflection walls 60c and the corresponding color LEDs, protection layers 65 made of a transparent resin are formed in the reflection portion 60b. Note that, the height of the base 60a and the height of the reflection portion 60b are 0.85 mm from the surface of the connection member 34.

By setting the reflection walls 60c to have an appropriate shape, light distribution property of the light emitting unit 32 can be changed. For example, in the backlight device 10 to which the present exemplary embodiment is applied, in order to emit light along a plane forming the back surface portion of the backlight frame 11, a configuration in which one side, closer to the back surface portion of the backlight frame 11, of the reflection wall 60c is formed to be parallel to the back surface portion, or the like is possible.

Next, with reference to FIG. 4, a description will be given of the connection between the light source connection members 33.

The terminal portion 35 includes a red terminal 41a provided to the red electric conductor 41, a first green terminal 42a provided to the first green electric conductor 42, a second green terminal 43a provided to the second green electric conductor 43, a blue terminal 44a provided to the blue electric conductor 44, a first heat terminal 51a provided to the first heat conductor 51, and a second heat terminal 52a provided to the second heat conductor 52. Here, the red terminal 41a, the first green terminal 42a, the second green terminal 43a and the blue terminal 44a are formed so that the adjacent two terminals are arranged at the same interval.

In a case of connecting the two light source connection members 33, the terminal portions 35 of the two light source connection members 33 are overlapped with each other, and each of the overlapped red terminals 41a, first green terminals 42a, second green terminals 43a, blue terminals 44a, first heat terminals 51a and second heat terminals 52a are swaged (crimped) by using a swaging member made of metal (not shown in the figure), for example. Thereby, each of the red electric conductors 41, the first green electric conductors 42, the second green electric conductors 43 and the blue electric conductors 44 provided to the light source connection members 33 are serially connected to each other through the corresponding color LEDs. Similarly, each of the first heat conductors 51 and the second heat conductors 52 provided to the light source connection members 33 are connected to each other.

Note that, in the present exemplary embodiment, since the one (the row of the) band-shaped light source 31 shown in FIG. 2A includes the 16 light emitting units 32 (8 front surface light emitting units 32a and 8 rear surface light emitting units 32b), the one band-shaped light source 31 is formed by connecting the 4 light source connection members 33. Here, in a case where the liquid crystal panel has a relatively small size, the band-shaped light source 31 can be formed by the one light source connection member 33. In a case where the one light source connection member 33 has a long length even if the liquid crystal panel has a relatively large size, the band-shaped light source 31 can be formed by the one light source connection member 33.

Here, with reference to FIGS. 1 to 5, a description of operation of the backlight device 10 will be given.

When a predetermined voltage is applied between the connectors 11a and 11b, a current flows in the electric conductors 40 of the light source connection members 33 forming the band-shaped light source 31. For example, the red electric conductors 41 are serially connected to each other through the front surface red color LEDs 61a provided to the front surface light emitting units 32a and the rear surface red color LEDs 61b provided to the rear surface light emitting units 32b. Here, the front surface light emitting units 32a and the rear surface light emitting units 32b form the band-shaped light source 31. As a result of the current flowing therethrough, the front surface red color LEDs 61a emit red light from the front surface side, and the rear surface red color LEDs 61b emit red light from the rear surface side. Also, the first green electric conductors 42 are serially connected to each other through the front surface first green color LEDs 62a provided to the front surface light emitting units 32a and the rear surface first green color LEDs 62b provided to the rear surface light emitting units 32b. Here, the front surface light emitting units 32a and the rear surface light emitting units 32b form the band-shaped light source 31. As a result of the current flowing therethrough, the front surface first green color LEDs 62a emit green light from the front surface side, and the rear surface first green color LEDs 62b emit green light from the rear surface side.

Further, the second green electric conductors 43 are serially connected to each other through the front surface second green color LEDs 63a provided to the front surface light emitting units 32a and the rear surface second green color LEDs 63b provided to the rear surface light emitting units 32b. Here, the front surface light emitting units 32a and the rear surface light emitting units 32b form the band-shaped light source 31. As a result of the current flowing therethrough, the front surface second green color LEDs 63a emit green light from the front surface side, and the rear surface second green color LEDs 63b emit green light from the rear surface side. Furthermore, the blue electric conductors 44 are serially connected to each other through the front surface blue color LEDs 64a provided to the front surface light emitting units 32a and the rear surface blue color LEDs 64b provided to the rear surface light emitting units 32b. Here, the front surface light emitting units 32a and the rear surface light emitting units 32b form the band-shaped light source 31. As a result of the current flowing therethrough, the front surface blue color LEDs 64a emit blue light from the front surface side, and the rear surface blue color LEDs 64b emit blue light from the rear surface side.

Specifically, each of the front surface light emitting units 32a emits red (R), green (G) and blue (B) light from the front surface side, and, similarly to this, each of the rear surface light emitting units 32b emits red (R), green (G) and blue (B) light from the rear surface side. In other words, in each of the band-shaped light sources 31, the red light, the green light and the blue light are emitted toward both of the front side F and the rear side R in the vertical direction V. Here, the red light, green light and blue light emitted by each of the band-shaped light sources 31 are sufficiently mixed in the backlight frame 11, and thereby a white light is obtained. Then, the mixed light is emitted toward the diffusing sheet 13 through the reflector and the reflection bodies 100 in the chassis of the backlight frame 11. Then, the emitted light is further mixed by the diffusing sheet 13 and the like, and then emitted to the liquid crystal display module 20.

FIG. 6 is a view for explaining the flow of current and the flow of heat in the light emitting unit 32. Note that, the description will be given by taking the front surface light emitting unit 32a included in the light emitting units 32 as an example. However, the same is true for the rear surface light emitting unit 32b. Here, as shown in FIG. 6, a current flows in the color LEDs from the left side to the right side in FIG. 6.

The front surface red color LED 61a and the front surface first green color LED 62a are attached onto the first projection portion 54 in the front surface light emitting unit 32a, and the rear surface red color LED 61b and the rear surface first green color LED 62b are attached onto the first projection portion 54 in the rear surface light emitting unit 32b. Thereby, the heat produced in the LEDs in accordance with the light emission flows into the first heat conductor 51 through the first projection portion 54. In other words, in this case, a heat radiation route is to be formed by the first heat conductor 51 including the first projection portion 54. Here, the first heat conductor 51 has a configuration in which the metal is exposed as mentioned above, and the heat flowing through the first projection portion 54 is released in the air from the exposed surface of the first heat conductor 51.

In addition, the front surface second green color LED 63a and the front surface blue color LED 64a are attached onto the second projection portion 55 in the front surface light emitting unit 32a, and the rear surface second green color LED 63b and the rear surface blue color LED 64b are attached onto the second projection portion 55 in the rear surface light emitting unit 32b. Thereby, similarly to the above, the heat produced in the LEDs in accordance with the light emission flows into the second heat conductor 52 through the second projection portion 55. In other words, in this case, a heat radiation route is to be formed by the second heat conductor 52 including the second projection portion 55. Here, the second heat conductor 52 has a configuration in which the metal is exposed similarly to that of the first heat conductor 51, and the heat flowing through the second projection portion 55 is released in the air from the exposed surface of the second heat conductor 52.

Alternatively, as another heat radiation route for the heat produced by the LEDs, a heat radiation member thermally connected to the first heat conductor 51 and the second heat conductor 52 may be provided to each of the connectors 11a and 11b to which the band-shaped light sources 31 are connected, to release heat to the backlight frame 11 through the heat radiation member. Still alternatively, a relay member having heat conductivity may be connected to the above-mentioned opening holes 53 with screws or the like at, for example, the central portion of the backlight frame 11, not only at the connecting points to the connectors 11a and 11b, to release heat to the backlight frame 11.

As mentioned above, the band-shaped light sources 31 to which the present exemplary embodiment is applied includes the above-mentioned heat radiation routes, and thereby the heat produced in the color LEDs is difficult to be held in the light emitting units 32, and the increase in temperature of the color LEDs slows down.

As mentioned above, the light emitted by the light emitting units 32 in each of the band-shaped light sources 31 travels along the back surface portion of the backlight frame 11, and then is emitted to the liquid crystal display module 20. At this time, while the red (G) light, green (G) light and blue (B) light emitted by the light emitting units 32 travel in the direction along the back surface portion, they are sufficiently mixed. Thereby, in the backlight device 10 to which the present exemplary embodiment is applied, the length of the backlight frame 11 in a thickness direction is made smaller than that in a so-called top-view type backlight device emitting light toward the liquid crystal display module 20 (in a direction along the side surface portions of the backlight frame 11), for example, since the light path length in the thickness direction of the backlight frame 11 for the color mixture is not necessary.

Thereby, it is possible to make the backlight device 10 thinner and to provide, for the liquid crystal display module 20, preferable white light having less color unevenness and the like.

As mentioned above, in the light emitting module 12, the front surface light emitting units 32a provided to the band-shaped light sources 31 are arrayed in the vertical direction V, and the rear surface light emitting units 32b provided to the band-shaped light sources 31 are also arrayed in the vertical direction V. Thus, when the light emitting units 32 are viewed in the vertical direction V, the light emitting directions in the same column are the same. Meanwhile, for example, in a case of an arrangement in which the front surface light emitting units 32a and the rear surface light emitting units 32b are arrayed in the vertical direction V, a portion where the light emission surface of the front surface light emitting unit 32a and the light emission surface of the rear surface light emitting unit 32b face each other is to be bright, and a portion where the opposite surface to the light emission surface of the front surface light emitting unit 32a and the opposite surface to the light emission surface of the rear surface light emitting unit 32b face each other is to be dark. Accordingly, in the backlight device 10 to which the present exemplary embodiment is applied, unevenness of brightness is suppressed by the arrangement in which the light emitting directions of the light emitting units 32 are set to be the same.

In the backlight device 10 to which the present exemplary embodiment is applied, the band-shaped light sources 31 are attached so as to stand on the back surface portion of the backlight frame 11. By this configuration in which the band-shaped light sources 31 stand in the backlight frame 11, it may be concerned that the band-shaped light sources 31 may shield light. However, since the electric conductors 40 and the heat conductors 50 forming the band-shaped light sources 31 have gaps, shaded areas in the backlight frame 11 is made small in comparison with a case where the plate substrate made of a glass-epoxy resin as a base material and having a predetermined wiring pattern is similarly used.

The band-shaped light sources 31 applied to the backlight device 10 in the present exemplary embodiment are a so-called double-sided light emission type. As mentioned above, the plural rows of the band-shaped light sources 31 are provided in the backlight frame 11. Thereby, for example, if one band-shaped light source 31 is set as a reference, the reference band-shaped light source 31 makes a shadow by putting, to the reference band-shaped light source 31, light emitted by the adjacent band-shaped light source located on one side. However, the shade can be illuminated with the light from the adjacent band-shaped light source 31 located on the other side. This relationship is established between the plural band-shaped light sources 31. As described above, the unevenness of brightness caused by the shade in the backlight frame 11 is further suppressed.

Note that, for example, 4 LEDs are provided to the first light emitting unit 321 shown in FIG. 3A. However, the number of the LEDs provided to the first light emitting units 321 is not limited to 4. Alternatively, not less than 4 LEDs or less than 4 LEDs may be provided to the first light emitting unit 321. In this case, in accordance with the number of the LEDs provided to the first light emitting unit 321, the design of the pattern shape of the electric conductor 40 of the connection member 34 may be appropriately changed.

In the above-mentioned exemplary embodiment, the red light emitting unit, the green light emitting unit and the blue light emitting unit are configured by the red color LEDs, the green color LEDs and the blue color LEDs, respectively. However, the red light emitting unit, the green light emitting unit and the blue light emitting unit may be configured by the combination of the blue color LEDs, UV LEDs or the like and fluorescent bodies. For example, in the first light emitting unit 321, the red light emitting unit may be configured by providing the front surface blue color LED 64a and by adding, to the protection layer 65 of the front surface blue color LED 64a, a fluorescent body emitting red light in response to receipt of blue light.

In the above-mentioned exemplary embodiment, as shown in FIG. 3A, for example, the 4 front surface LEDs are provided to the first light emitting unit 321, and the 4 rear surface LEDs are provided to the second light emitting unit 322, and thereby they function as the front surface light emitting unit 32a and the rear surface light emitting unit 32b, respectively. Alternatively, for example, 2 front surface LEDs and 2 rear surface LEDs may be provided to the first light emitting unit 321. In such a configuration, the first light emitting unit 321 functions as both of the front surface light emitting unit 32a and the rear surface light emitting unit 32b.

FIG. 7 is a view for explaining another shape of the reflection wall 60c of the reflection member 60. Note that, the description will be given by taking the first light emitting unit 321 shown in FIG. 4 as an example. However, the other light emitting units such as the second light emitting unit 322 are the same. In addition, the same reference numerals are applied to the members that have already been described with reference to FIG. 4 or the like, and the description thereof will be omitted.

The shape of the reflection wall 60c of the reflection member 60 in the first light emitting unit 321 shown in FIG. 7 is different from that of the first light emitting unit 321 described with reference to FIG. 4. In this example, as shown in FIG. 7, the one reflection wall 60c is formed for the front surface red color LED 61a, the front surface first green color LED 62a, the front surface second green color LED 63a and the front surface blue color LED 64a. As described above, instead of forming one reflection wall 60c per LED, forming one reflection wall 60c for plural LEDs is acceptable.

In the above-mentioned case, the same color LEDs may be provided in the one reflection wall 60c, such as a case in which 4 front surface blue color LEDs 64a are provided in the first light emitting unit 321. Further, by adding the fluorescent body to the protection layer 65 as described above, light of a desired color may be emitted.

In the present exemplary embodiment, the description has been given of the example in which the band-shaped light sources 31 (light source connection members 33) are used as the backlight of the liquid crystal display device. However, the example of the application of the band-shaped light source 31 is not limited to this. As mentioned above, by connecting the light source connection members 33 as basic units to each other, the band-shaped light source 31 having longer length than that applied to the backlight device 10 can be obtained. Thus, for example, the band-shaped light source 31 can be used for roadway lighting such as centerline light of a road. Here, in the case of using the band-shaped light source 31 as the roadway lighting, the amount of heat generation is assumed to be increased due to the increase of the amount of light emission (power consumption) derived from its own usage, in comparison with the case where the band-shaped light source 31 is applied to the backlight of the liquid crystal display device. However, the band-shaped light source 31 to which the present exemplary embodiment is applied has the heat conductor 50, and thereby the heat produced from the LEDs can be efficiently released.

Note that, in the above description, the surfaces expressed as the front surface and the rear surface are defined for descriptive purposes, and thus the front surface and the rear surface may be arbitrary selected.

### BRIEF DESCRIPTION OF THE DRAWINGS

FIG. 1 is a view showing an entire configuration of a liquid crystal display device to which the exemplary embodiment is applied;

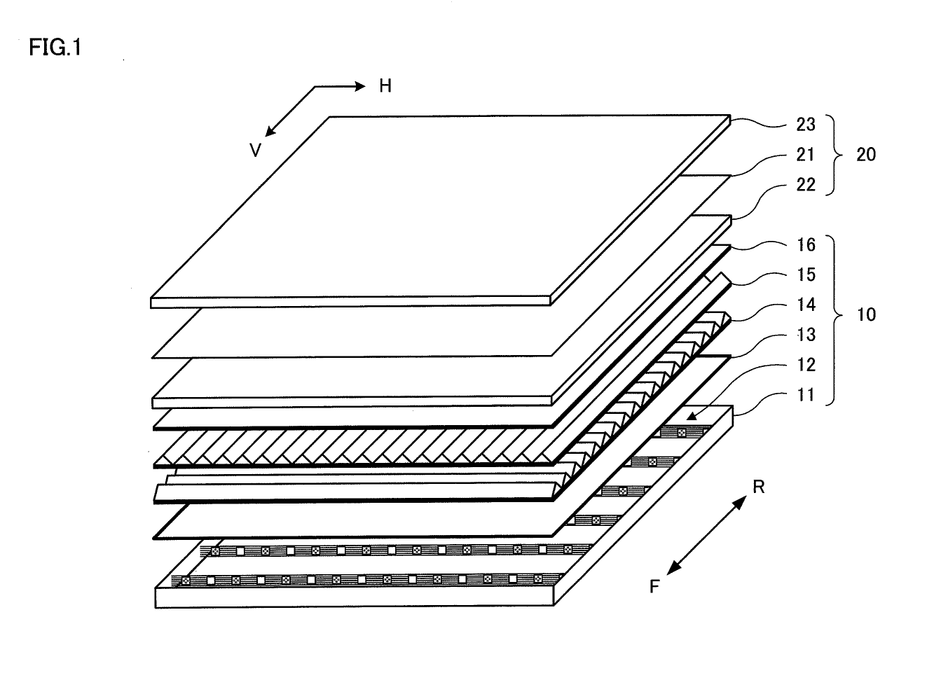

FIGS. 2A, 2B and 2C are views for explaining the configuration of the backlight device;

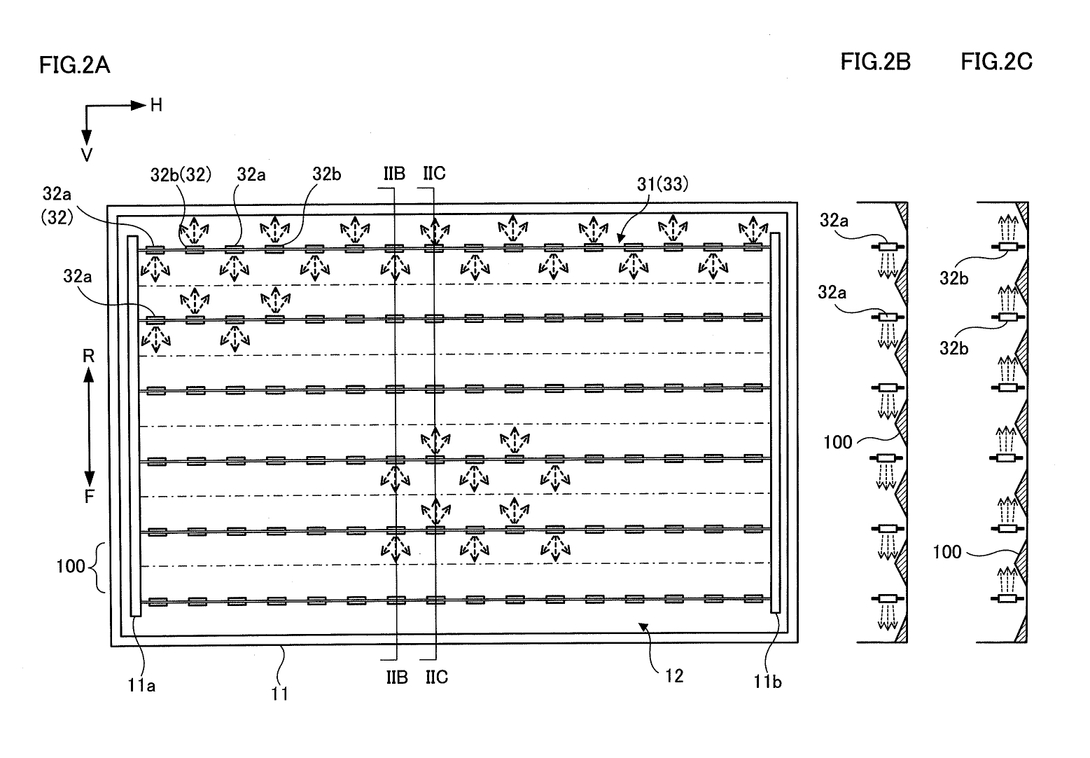

FIGS. 3A and 3B are views for explaining a light source connection member forming the band-shaped light source;

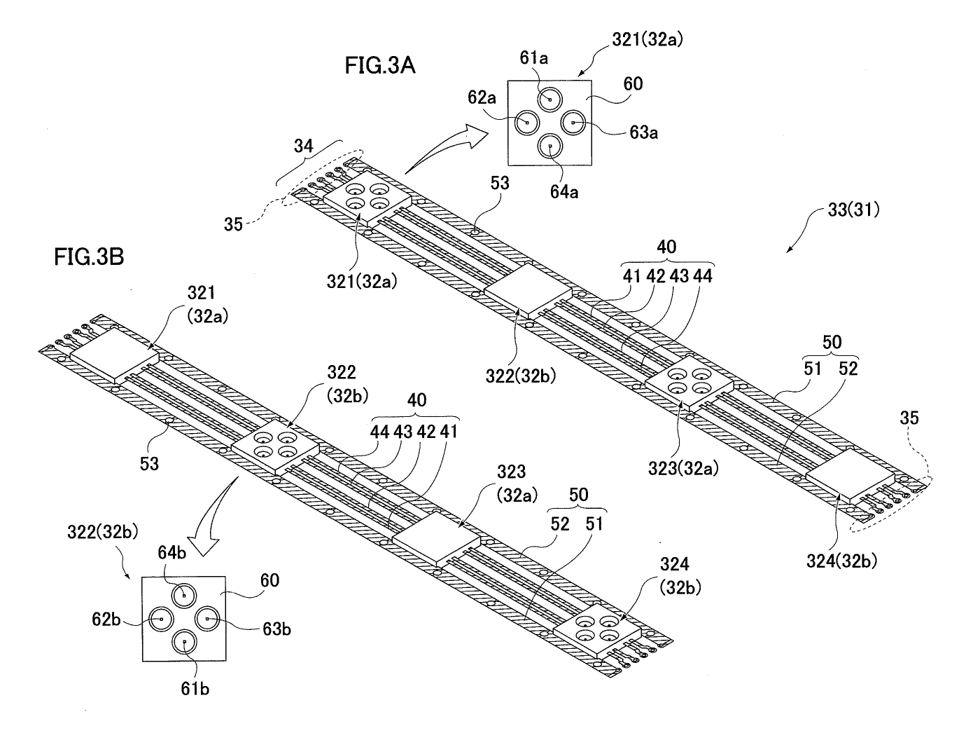

FIG. 4 is a view for explaining a wiring structure in the light emitting unit and the configuration of the terminal portion;

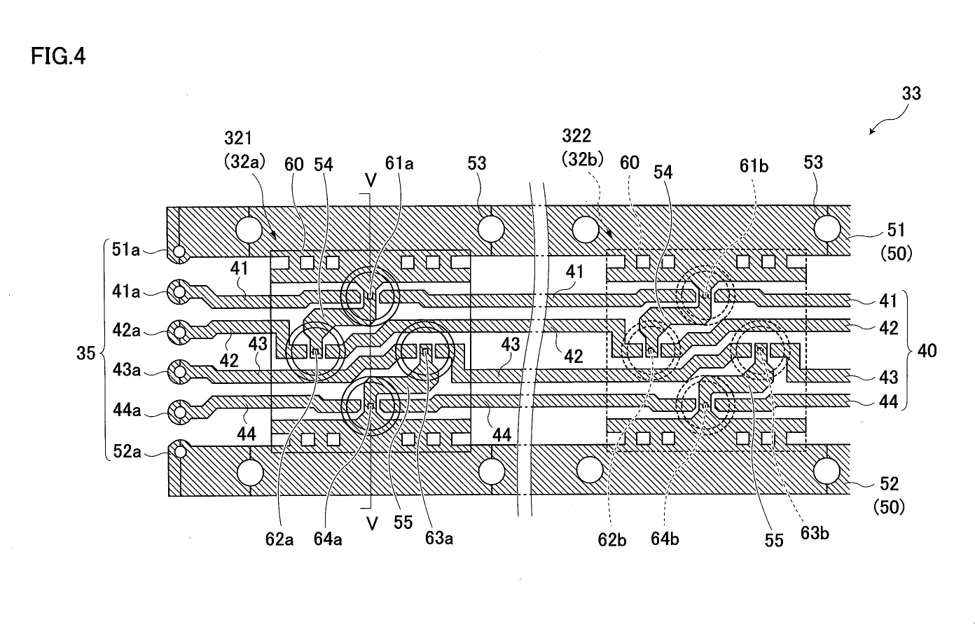

FIG. 5 is a cross-sectional view of FIG. 4 taken along a line V-V;

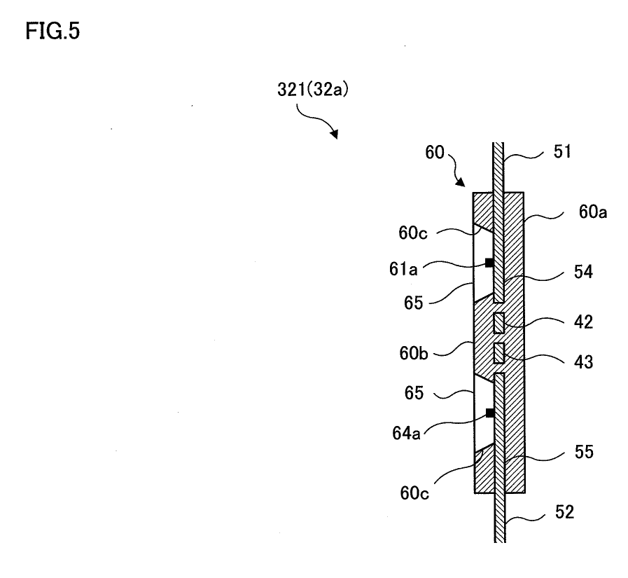

FIG. 6 is a view for explaining the flow of current and the flow of heat in the light emitting unit; and

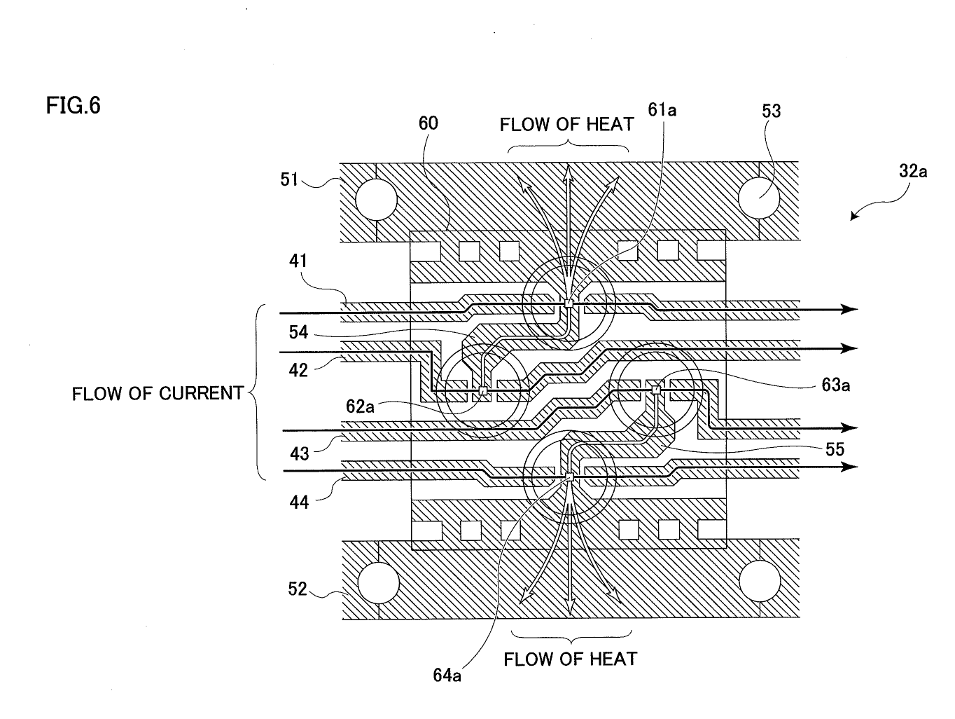

FIG. 7 is a view for explaining another shape of the reflection walls of the reflection member.

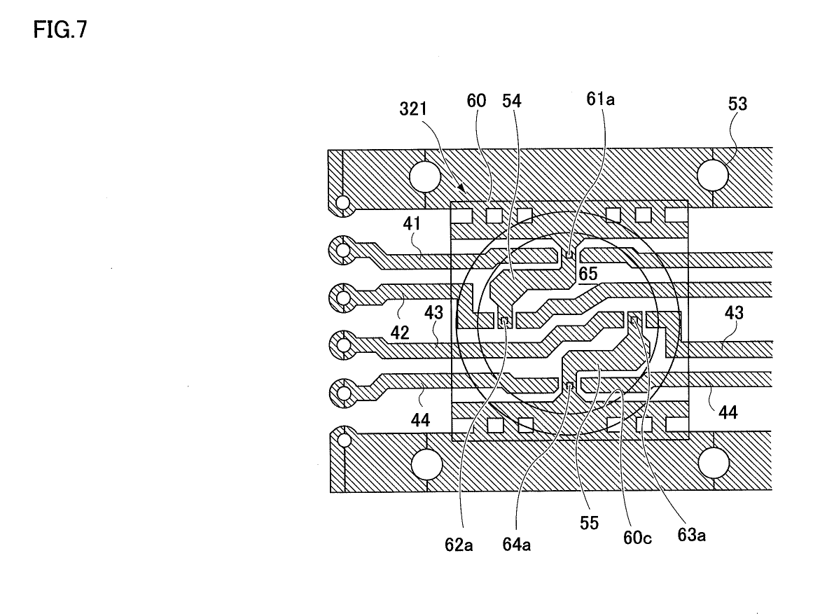

### DESCRIPTION OF REFERENCE NUMERALS AND SIGNS

10 . . . backlight device
11 . . . backlight frame
12 . . . light emitting module
20 . . . liquid crystal display module
31 . . . band-shaped light source
32 . . . light emitting unit
32a . . . front surface light emitting unit
32b . . . rear surface light emitting unit
33 . . . light source connection member
34 . . . connection member
35 . . . terminal portion
40 . . . electric conductor
41 . . . red electric conductor
42 . . . first green electric conductor
43 . . . second green electric conductor
44 . . . blue electric conductor
50 . . . heat conductor
51 . . . first heat conductor
52 . . . second heat conductor
54 . . . first projection portion
55 . . . second projection portion
60 . . . reflection member
61a . . . front surface red color LED
62a . . . front surface first green color LED
63a . . . front surface second green color LED
64a . . . front surface blue color LED
61b . . . rear surface red color LED
62b . . . rear surface first green color LED
63b . . . rear surface second green color LED
64b . . . rear surface blue color LED

1. A light source connection member comprising:
a plurality of light sources; and
a metallic conductor that has a front surface and a rear surface and through which the plurality of light sources are connected to each other to form the light source connection member, wherein
the metallic conductor comprises an electric conductor that is electrically connected to the plurality of light sources and that forms an electric power supply route for the plurality of light sources, and
the plurality of light sources comprise a front surface light source that emits light from the front surface side of the metallic conductor and a rear surface light source that emits light from the rear surface side of the metallic conductor.

2. The light source connection member according to claim 1, wherein the metallic conductor further comprises a heat conductor that is provided so as to be electrically isolated from the electric conductor on the same plane as the electric conductor, and that forms a heat radiation route for heat produced by the front surface light source and the rear surface light source.

3. The light source connection member according to claim 2, wherein
the front surface light source comprises a front surface light emitting element that is attached to the front surface of the heat conductor, and
the rear surface light source comprises a rear surface light emitting element that is attached to the rear surface of the heat conductor.

4. The light source connection member according to claim 1, wherein
each of the front surface light source and the rear surface light source comprises a red light emitting unit, a green light emitting unit and a blue light emitting unit, respectively, and
the electric conductor comprises a red electric conductor that serially connects the red light emitting unit provided to the front surface light source and the red light emitting unit provided to the rear surface light source to each other, a green electric conductor that serially connects the green light emitting unit provided to the front surface light source and the green light emitting unit provided to the rear surface light source to each other, and a blue electric conductor that serially connects the blue light emitting unit provided to the front surface light source and the blue light emitting unit provided to the rear surface light source to each other.

5. A light emitting device comprising:
a frame that has a back surface portion and side surface portions enclosing the back surface portion; and
a band-shaped light source that is formed by connecting a plurality of light sources through a metallic conductor having a front surface and a rear surface, and that is attached to the frame, wherein
the metallic conductor comprises an electric conductor that is electrically connected to the plurality of light sources and that forms an electric power supply route for the plurality of light sources,
the plurality of light sources comprise a front surface light source that emits light from the front surface side of the metallic conductor and a rear surface light source that emits light from the rear surface side of the metallic conductor, and
the band-shaped light source is attached to the frame so that the front surface light source and the rear surface light source face the side surface portions, respectively.

6. The light emitting device according to claim 5, wherein
the back surface portion of the frame comprises a reflection body formed thereon, the reflection body being provided along the band-shaped light source, and reflecting light emitted by the front surface light source and the rear surface light source.

7. A display device comprising:
a display panel that displays an image; and
a backlight that is provided on a back side of the display panel, and that illuminates the display panel with light, wherein
the backlight comprises:
a frame that has a back surface portion arranged so as to face the display panel, and side surface portions enclosing the back surface portion; and
a plurality of band-shaped light sources that are each formed by connecting a plurality of light sources through a metallic conductor having a front surface and a rear surface, and that are attached to the frame so as to be arrayed, wherein
the metallic conductor comprises an electric conductor that is electrically connected to the plurality of light sources and that forms an electric power supply route for the plurality of light sources,
the plurality of light sources comprise a front surface light source that emits light from the front surface side of the metallic conductor and a rear surface light source that emits light from the rear surface side of the metallic conductor, and
each of the plurality of band-shaped light sources is attached to the frame so that the front surface light source and the rear surface light source face the side surface portions, respectively.

8. The display device according to claim 7, wherein, in each of the plurality of band-shaped light sources, arrangement of the front surface light source and the rear surface light source at each column is the same.
